(19) United States
(12) Patent Application Publication
(10) Pub. No.: US 2026/0242135 A1
(43) Pub. Date: Aug. 20, 2026

(54) A METHOD FOR ADAPTING A GOODS HOLDER AND AN ADAPTER FOR A GOODS HOLDER

(71) Applicant: AutoStore Technology AS, Nedre Vats (NO)

(72) Inventor: Jørgen Heggebø, Langhus (NO)

(21) Appl. No.: 19/161,161

(22) PCT Filed: Mar. 6, 2024
(86) PCT No.: PCT/EP2024/055883

§ 371 Date: Aug. 29, 2025

(30) Foreign Application Priority Data
Mar. 6, 2023 (NO) 20230229

(51) Int. Cl. B65G 1/04; B65D 5/42; B66C 19/00

(52) U.S. Cl. CPC B65G 1/0464; B65D 5/42; B66C 19/00

(57) ABSTRACT

The disclosure relates to a method for adapting a goods holder (106) handled by a remotely operated vehicle (201, 301, 401) of a grid-based storage and retrieval system (1). The method comprises: providing an adapter (109) comprising a quadrangular frame (19) with at least one hollow projection (21) extending perpendicularly from said quadrangular frame (19), engaging the at least one projection (21) by a gripper (44) of a gripper device (46) of said remotely operated vehicle (201, 301, 401), positioning said remotely operated vehicle (201, 301, 401) so that said adapter (109) is positioned above and aligned with the goods holder (106), with the at least one projection (21) aligned with a corresponding gripper hole (33) in an upper edge (31) section of the goods holder (106), lowering the adapter (109) using the gripper device (46) so that the quadrangular frame (19) is adjacent the upper edge (31) section of the goods holder (106), affixing the adapter (109) to the upper edge (31) section of the goods holder (106) by inserting the at least one projection (21) into the corresponding gripper hole (33) of the goods holder (106). The disclosure further relates to an adapter (109) for a goods holder (106).

The present invention primarily relates to a method for adapting a goods holder so that it becomes engageable by a gripper of a gripper device of a remotely operated vehicle operating in a grid-based storage and retrieval system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1. The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a gripper device 304, 404 (visible in FIGS. 3a-3b) for vertical transportation of storage containers 106, e.g. raising a storage container 106 from, and lowering a storage container 106 into, a storage column 105. The gripper device 304, 404 comprises one or more grippers which are adapted to engage a storage container 106 by means of insertion in gripper holes of the goods holder. Furthermore, the gripper device can be lowered from the vehicle 201, 301, 401 so that the position of the gripper device with respect to the vehicle 201, 301, 401 can be adjusted in a third direction Z (visible for instance in FIG. 1) which is orthogonal the first direction X and the second direction Y. Parts of the gripper device of the container handling vehicles 301, 401 are shown in FIGS. 3a and 3b. The gripper device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1.

FIG. 3a shows an alternative configuration of a container handling vehicle 301 with a cantilever construction. Such a vehicle is described in detail in e.g. NO317366.

The cavity container handling vehicles 201 shown in FIG. 2 may have a footprint that covers an area with dimensions in the X and Y directions which is generally equal to the lateral extent of a storage column 105, e.g. as is described in WO2015/193278A1. The term ‘lateral’used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1 illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

Storage containers of the system of FIG. 1 are optimized for use within the storage volume and are not particularly well-suited for use outside the system. In view of this, it is desirable to provide a solution that suitably adapts the storage container. In this context, it is desirable that the method for adapting the container is simple and standardized.

### SUMMARY OF THE INVENTION

The present invention to which this patent relates is set forth and characterized in the independent claims, while the dependent claims describe other optional features of embodiments of the invention to which this patent relates.

A first aspect relates to method for adapting a goods holder handled by a remotely operated vehicle of a grid-based storage and retrieval system, said method comprising:
providing an adapter comprising a quadrangular frame with at least one hollow projection extending perpendicularly from said quadrangular frame,
engaging the at least one projection by a gripper of a gripper device of said remotely operated vehicle,
positioning said remotely operated vehicle so that said adapter is positioned above and aligned with the goods holder, with the at least one projection aligned with a corresponding gripper hole in an upper edge section of the goods holder,
lowering the adapter using the gripper device so that the quadrangular frame is adjacent the upper edge section of the goods holder,
affixing the adapter to the upper edge section of the goods holder by inserting the at least one projection into the corresponding gripper hole of the goods holder.

The order of the steps in the method as listed above is not to be construed as a strict limitation, and the steps may occur in another order.

A goods holder adapted in accordance with the above preserves all advantages associated with the standard goods holders, for instance goods holders being easily stackable within the storage volume. In addition, use of the adapter improves overall stability when a stack of goods holders is freestanding outside the storage volume, i.e. is not supported by means of the upright members defining the storage column. Moreover, the adapter can also act as a structural reinforcement that increases the strength of the goods holder and reduces the risk of goods holder deformation due to external forces. Here, the adapter is particularly useful during goods holder transport and at a micro fulfilment center (MFC). As is known in the art, an MFC is a small-scale warehouse facility typically placed close to the consumer to improve delivery times.

Furthermore, by employing the gripper of the gripper device suspended from the remotely operated vehicle, the adapter may be installed in a quick, fully automatized process that increases efficiency and eliminates man-made errors.

Installing of the adapter may take place within the storage volume or outside the volume, provided that the goods holder to be adapted may be accessed by a remotely operated vehicle.

In a related context, fully-automated adapter installation process opens for deployment in particularly demanding conditions, such as freezer rooms and/or clean rooms.

Another aspect relates to an adapter for a goods holder in accordance with claim 5. For the sake of brevity, advantages discussed above in connection with the method may even be associated with the adapter and are not further discussed.

In one aspect, the goods holder adapter is for use in the context of the framework structure 100 comprising upright members 102.

In another aspect, the goods holder adapter is for use in the context of a storage volume comprising storage columns 105 for storing stacks of goods holders 106. These storage columns 105 are arranged in rows between the upright members 102.

In another aspect, the goods holder adapter is for use in the context of a rail system 108 arranged across the top of the framework structure 100. Here, a plurality of remotely operated vehicles travels on the rail system 108 and raises goods holders 106 from, and lowers goods holders 106 into, the storage columns 105, and also to transport the goods holders 106 above the storage columns 105. During this transport, the remotely operated vehicles move laterally, i.e. in a plane which is parallel to a horizontal plane.

In one aspect, the goods holder adapter is for use in the context of a SDG-based rail system 108. Here, SDG stands for Single/Double Grid. This design provides a single rail track along one axis and a double rail track along the other axis. Utilizing a single rail in one direction requires the meeting robots to have a cell between them.

In one aspect, the goods holder adapter is for use in the context of a DDG-based rail system 108. Here, DDG stands for Double/Double Grid. This design provides a double rail track in all directions allowing robots to pass each other in all directions.

For the purposes of this application, the term “container handling vehicle” used in “Background and Prior Art”-section of the application and the term “remotely operated vehicle” used in the rest of the application text are synonymous and define an autonomous wheeled vehicle operating on a rail system arranged across the top of the framework structure being part of an automated storage and retrieval system. Analogously, the terms “storage container” and “storage bin” used in “Background and Prior Art”-section of the application and the term “goods holder” used in the rest of the application text are synonymous and define a vessel for storing items. In a related context, the goods holder of the present application can be any one of a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position close to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention to which this patent relates. The drawings show embodiments of the invention to which this patent relates, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view, seen from below, of a prior art container handling vehicle having an internally arranged cavity for carrying storage containers therein.

FIG. 4a is a perspective view from below showing an adapter in accordance with one example.

FIG. 4b is a perspective view from above showing the adapter of FIG. 4a.

FIG. 4c is a top view showing the adapter of FIGS. 4a-4b.

FIG. 5a is a perspective side view showing an adapter when engaged by a gripper, when said adapter is approaching an underlying goods holder.

FIG. 5b is a perspective view showing an adapter when installed on a goods holder.

FIG. 5c is a cross-sectional view showing an adapter when engaged by a gripper.

FIG. 6a shows an adapter in accordance with another embodiment of the present invention, wherein said adapter is adjacent an underlying goods holder.

FIG. 6b Shows the Adapter of FIG. 6a When Installed on the Goods Holder.

FIG. 7 is a perspective view showing a standard goods holder with an adapter in accordance with an example affixed to an upper edge section of the goods holder and a further goods holder being stacked on the adapted goods holder.

### DETAILED DESCRIPTION OF THE INVENTION

In the following, examples will be discussed in more detail, by way of example only and with reference to the appended drawings. It should be understood, however, that the drawings are not intended to limit the invention to which this patent relates to the subject-matter depicted in the drawings.

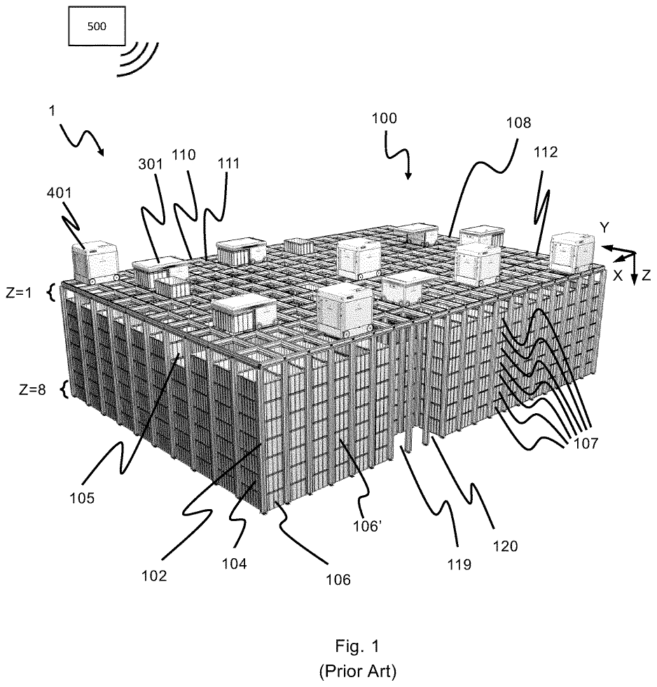

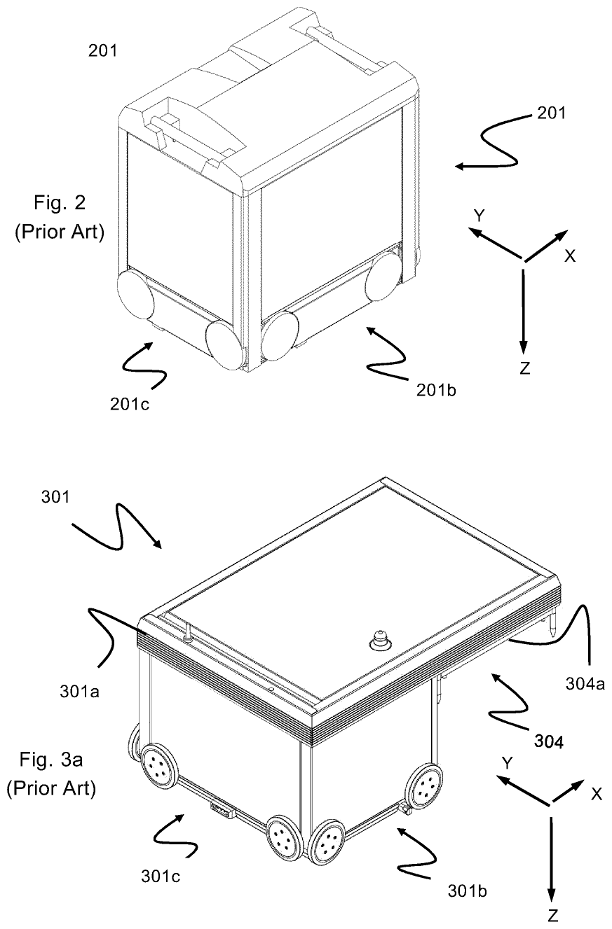

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

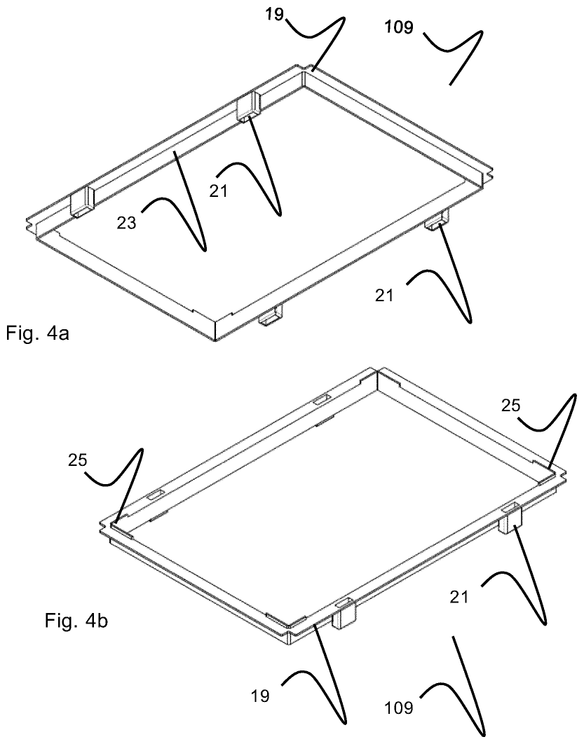

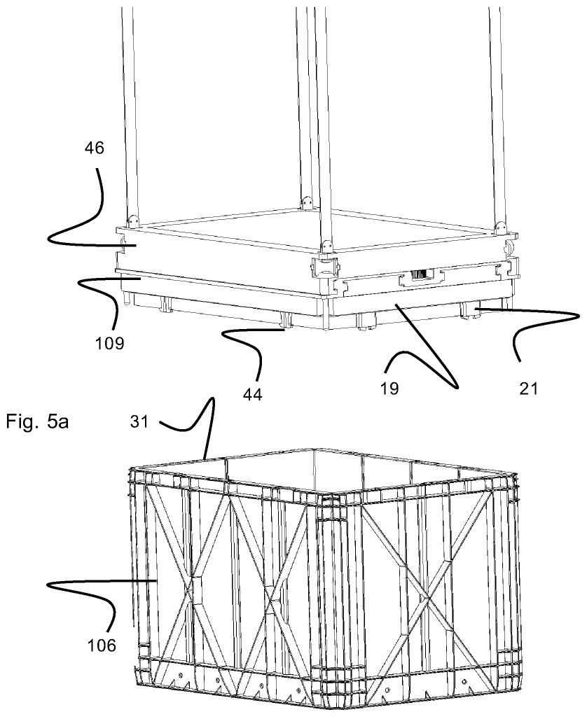

Various examples will now be discussed in more detail with reference to FIGS. 4-7.

FIG. 4a is a perspective view showing an adapter 109 in accordance with one example, said adapter 109 being shown from below. FIG. 4b is a perspective view showing the adapter of FIG. 4b from above.

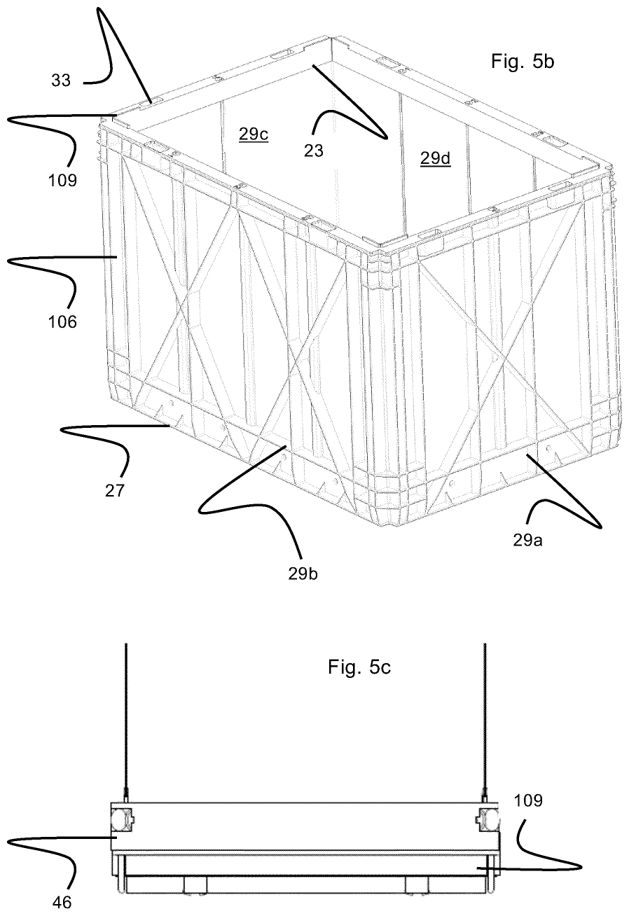

Adapter shown in FIGS. 4a-4b comprises a quadrangular frame 19 and a plurality of projections 21 extending perpendicularly from the quadrangular frame 19 and formed integrally with the frame. The adapter is preferably made in polymer material and it may be manufactured in one go, for instance casted. The projections are hollow. Proximal opening of each projection is arranged flush with an upper frame surface. In one example, inner hollow volume of the projection is cylindrically shaped and has uniform diameter. The projections are positioned so as to correspond to gripper holes of a goods holder for a storage and retrieval system of FIG. 1, said goods holder being shown and discussed in connection with FIG. 5a. Shown adapter 109 further comprises an inner rim section 23 extending perpendicularly from the quadrangular frame 19 in the same direction, i.e. in parallel, as the projections. The projections 21 are for insertion into gripper holes of the goods holder (shown in FIG. 5a). Once the projections 21 are inserted, a friction fit ensures that these projections 21 are firmly secured in the gripper holes so that the frame 19 of the adapter 109 is immobilized relative the goods holder 106. As clearly seen, the projections 21 extend further down then the inner rim section 23.

Moreover and as seen in FIG. 4b, the adapter 109 comprises a plurality of flanges 25 each located at a corner of the quadrangular frame 19, said flanges 25 extending perpendicularly from the frame 19 in a direction opposite to extension direction of the inner rim section 23.

With reference to FIG. 4a, the projections 21 have an open distal end, i.e. the end facing away from the frame 19. To facilitate insertion, the projections 21 could have rounded edges. For the same reason, the projections 21 could taper away from the frame. With reference to FIG. 4b, corner sections of the frame comprise guiding flanges 25 extending perpendicularly from the frame in the opposite direction to the direction that the at least one projection extends. These guiding flanges 25 are for guiding an arriving goods holder being lowered on the adapted underlying goods holder.

FIG. 4c is a top view of the adapter 109 of FIGS. 4a-4b. For the sake of brevity, features of the adapter shown in FIG. 4c are not further discussed, and the reference is made to corresponding discussion presented in conjunction with FIGS. 4a-4b.

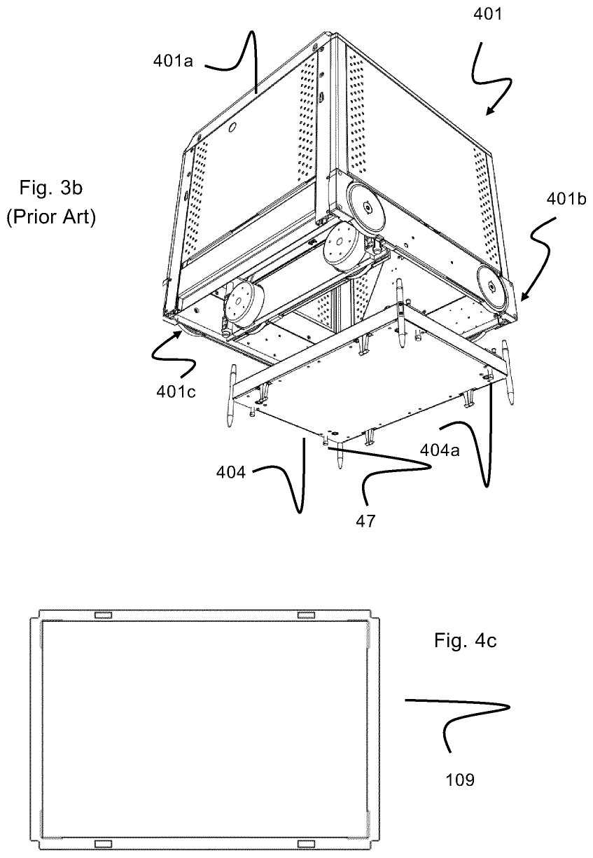

FIG. 5a is a perspective side view showing an adapter 109 when engaged by a gripper device 46, when said adapter 109 is approaching an underlying goods holder 106. The purpose of the operation is to adapt a goods holder 106 handled by a remotely operated vehicle (not shown) of a grid-based storage and retrieval system of FIG. 1. An adapter 109 comprising a quadrangular frame 19 with hollow projections 21 extending perpendicularly from said quadrangular frame 19 is provided. Such an adapter 109 has been shown and discussed in connection with FIGS. 4a-4c. Projections 21 of the adapter are engaged, i.e. traversed, by grippers 44 of a gripper device 46 of the remotely operated vehicle (not shown). The remotely operated vehicle needs to be positioned so that adapter 109 is positioned above and aligned with the underlying goods holder 106, with each projection 21 being aligned with a corresponding gripper hole (not visible in FIG. 5a) in an upper edge section 31 of the goods holder 106. Subsequently, the adapter 109 is lowered so that the quadrangular frame 19 is adjacent the upper edge section 31 of the goods holder 106, whereupon the adapter 109 is affixed to the upper edge section 31 of the goods holder 106 by inserting each projection 21 into the corresponding gripper hole of the goods holder 106. As stated above, once the projections 21 are inserted, a friction fit ensures that these projections 21 are firmly secured in the gripper holes so that the adapter 109 is immobilized relative the goods holder 106. Typically, the adapter 109 is pushed downward when the frame 19 is adjacent the upper edge section 31 of the goods holder 106 such that the projections 21 are firmly secured in the gripper holes. Regardless of the gripper device design or the adapter design, this pushing motion is typically effected by means of a set of pre-existing spring-loaded sensors 47, also called bin bottom sensors. These are normally used to establish state/exact position of the gripper device 46 relative to the goods holder 106. A bin bottom sensor 47 is shown in FIG. 3b. Alternative ways of ensuring that the projections are firmly secured in the gripper holes, i.e. other than friction fit, are also conceivable.

Once the adapter 19 is affixed to the goods holder 106, the grippers 44 of the gripper device 46 disengage from the projections 21. Subsequently, the grippers 44 engage from below with the goods holder 106 in a well-known manner, notwithstanding the presence of the projections 21 in the gripper holes 33. Alternatively, the grippers 44 are removed from the projections 21 inserted in the gripper holes 33.

FIG. 5b is a perspective view showing an adapter 109 when installed on a goods holder 106. Normally, the adapter 109 is affixed to the upper edge section of the goods holder when the goods holder 106 is disposed in a storage column of the grid-based storage and retrieval system of FIG. 1. Shown assembly comprises a goods holder 106 comprising a base 27 and four sides 29a-29d extending from the base 27, the four sides defining an upper edge 31 opposite the base 27. The assembly further comprises an adapter 109 as shown and discussed in connection with FIG. 4a. The adapter 109 is releasably affixed to the upper edge of the goods holder 106, and it does not extend outwardly of an outer perimeter of the goods holder 106 defined by the four sides 29a-29d. As previously discussed, the goods holder 106 comprises gripper holes 33 in its upper edge, and the projections of the adapter 109 are inserted into said holes 33. An inner rim section 23 is inserted into the goods holder 109 and is in contact with an inner surface of the goods holder 109. For the sake of brevity, further features of the adapter shown in FIG. 5b are not further discussed, and the reference is made to corresponding discussion presented in conjunction with FIG. 5a.

A goods holder adapted in accordance with the above preserves all advantages associated with the standard goods holders, for instance goods holders being easily stackable within the storage volume. In addition, use of the adapter improves overall stability when a stack of goods holders is freestanding outside the storage volume, i.e. is not supported by means of the upright members defining the storage column. Moreover, the adapter can also act as a structural reinforcement that increases the strength of the goods holder and reduces the risk of goods holder deformation due to external forces. Here, the adapter is particularly useful during goods holder transport and at a micro fulfilment center (MFC). As is known in the art, an MFC is a small-scale warehouse facility typically placed close to the consumer to improve delivery times.

Furthermore, by employing the gripper of the gripper device suspended from the remotely operated vehicle, the adapter may be installed in a quick, fully automatized process that increases efficiency and eliminates man-made errors.

Installing of the adapter may take place within the storage volume or outside the volume, provided that the goods holder to be adapted may be accessed by a remotely operated vehicle.

In a related context, fully-automated adapter installation process opens for deployment in particularly demanding system conditions, such as freezer rooms and/or clean rooms.

FIG. 5c is a cross-sectional view showing an adapter 109 when engaged by grippers (not visible in FIG. 5c) of a gripper device 46.

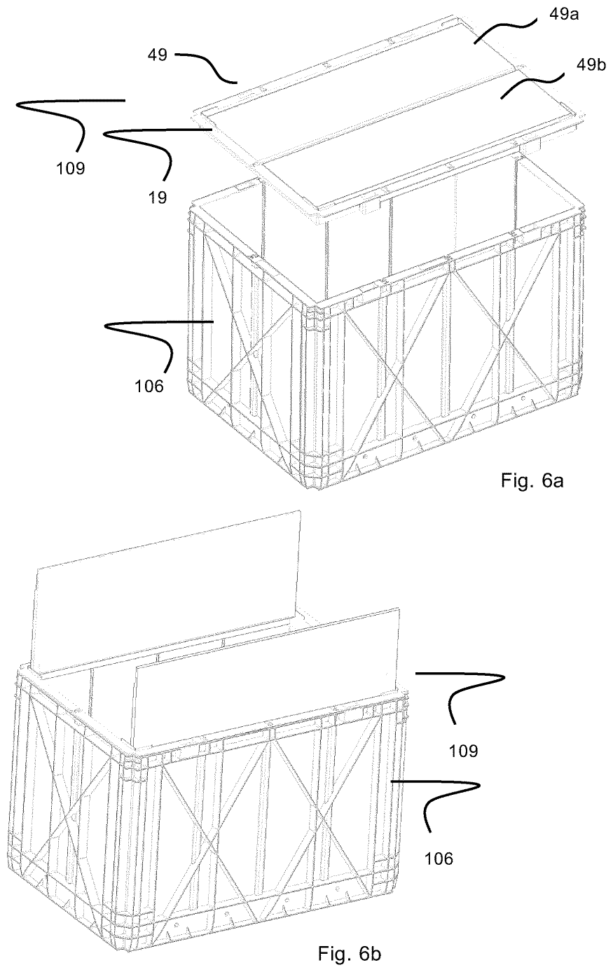

FIG. 6a shows an adapter 109 in accordance with another example. Shown adapter 109 comprises a central lid part 49, said central lid part 49 for completely covering a top side of the goods holder 106 when said adapter 109 is affixed to the upper edge of the goods holder 106. The central lid part 49 comprises two lid portions 49a, 49b which are connected to the frame 19 by a respective hinge and which can each be pivoted about their respective hinge so as to lift up or drop down to allow access to the interior of the goods holder 106. FIG. 6b shows the adapter 109 of FIG. 6a when installed on the goods holder 106. The affixing process is substantially identical to that described in connection with FIG. 5a. For the sake of brevity, further features shown in FIG. 6b are not further discussed here, and the reference is made to corresponding discussion presented in conjunction with FIG. 6a.

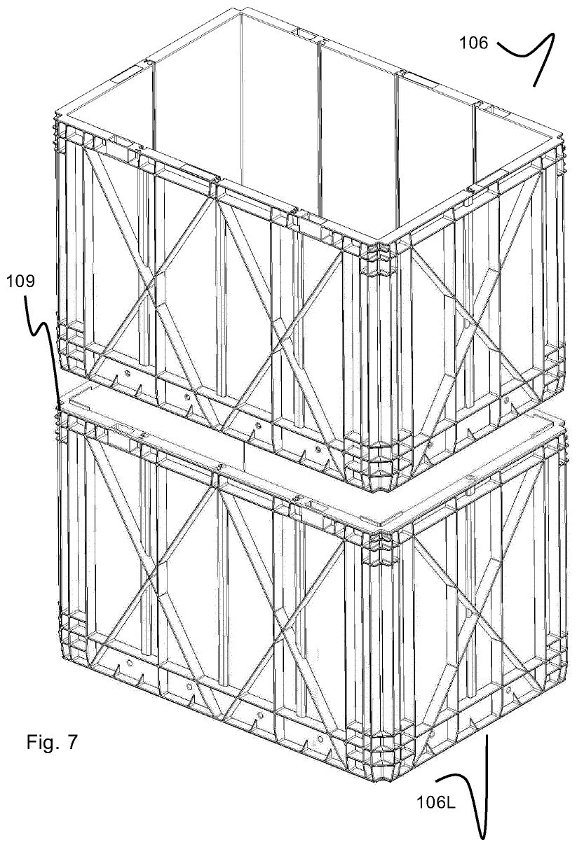

FIG. 7 is a perspective view showing a stack of goods holders 106. More specifically, it is shown a standard goods holder 106L with an adapter 109 affixed to an upper edge section of the goods holder 106L and a further goods holder 106 being stacked on the adapted goods holder 106L such that the adapter 109 is sandwiched between the goods holder 106 and the adapted goods holder 106L. For the sake of brevity, further features shown in FIG. 7 are not further discussed, and the reference is made to corresponding discussion presented in conjunction with FIGS. 4a-6b. Goods holder stack of FIG. 7 may be stored in an automated storage and retrieval system, for instance that of FIG. 1, comprising a framework structure 100 with upright members 102, a storage volume comprising storage columns 105 provided between the members, wherein goods holders 106 are stackable in stacks 107 within the storage columns 105, a rail system 108 provided on top of the upright members 102, with remotely operated vehicles moving on the rail system 108.

In the preceding description, various aspects of the adapter for a goods holder and a method for adapting a goods holder according to the invention have been described with reference to the illustrative examples. For purposes of explanation, specific numbers, systems and configurations were set forth in order to provide a thorough understanding of the system and its workings. However, this description is not intended to be construed in a limiting sense. Various modifications and variations of the illustrative example, as well as other examples of the system, which are apparent to persons skilled in the art to which the disclosed subject matter pertains, are deemed to lie within the scope of the present disclosure.

The present disclosure also comprises the following clauses:

A1. A method for adapting a goods holder handled by a remotely operated vehicle of a grid-based storage and retrieval system, said method comprising:
providing an adapter comprising a quadrangular frame with at least one hollow projection extending perpendicularly from said quadrangular frame,
engaging the at least one projection by a gripper of a gripper device (46) of said remotely operated vehicle,
positioning said remotely operated vehicle so that said adapter is positioned above and aligned with the goods holder, with the at least one projection aligned with a corresponding gripper hole in an upper edge section of the goods holder,
lowering the adapter using the gripper device so that the quadrangular frame is adjacent the upper edge section of the goods holder,
affixing the adapter to the upper edge section of the goods holder by inserting the at least one projection into the corresponding gripper hole of the goods holder.

A2. The method of clause A1, the method comprising:
affixing the adapter to the upper edge section of the goods holder when the goods holder is disposed in a storage column of the grid-based storage and retrieval system.

### A3. the Method of Clause A1 or A2, Said Method Comprising:

pushing the adapter downward when said quadrangular frame is adjacent the upper edge section of the goods holder such that the at least one projection becomes firmly secured in the gripper hole.

### A4. the Method of Any of Clauses Al to A3, Said Method Comprising:

passing the gripper of the gripper device through the at least one projection when said projection is inserted in the gripper hole of the goods holder,
engaging the goods holder by said gripper,
lifting the goods holder.

A5. An adapter for a goods holder, the adapter comprising:
a quadrangular frame;
at least one projection extending perpendicularly from the quadrangular frame, wherein said projection is hollow.

A6. An adapter of clause A5, wherein said projection has an open distal end.

A7. An adapter of clause A5 or A6, wherein said projection has rounded edges.

A8. An adapter of clause A5 or A6 or A7, wherein said projection tapers away from the frame.

A9. An adapter of any of clauses A5 to A8, wherein the adapter comprises an inner rim section which extends perpendicularly from the frame in the same direction as the at least one projection.

A10. An adapter of any of clauses A6 to A9, wherein at least one corner section of the frame comprises a guiding flange extending perpendicularly from the frame in the opposite direction to the direction that the at least one projection extends.

A11. An adapter of any of clauses A5 to A10, wherein the adapter is for use in the method of any of clauses Al to A4.

A12. A goods holder and adapter assembly, comprising:
a goods holder comprising a base and four sides extending from the base, the four sides defining an upper edge opposite the base; and
the adapter as of any of clauses A5 to A11,
wherein the adapter is attached to the upper edge of the goods holder, and wherein the adapter does not extend outwardly of an outer perimeter of the goods holder defined by the four sides.

A13. A goods holder and adapter assembly of clause A12, wherein the adapter is releasably affixed to the upper edge of the goods holder.

A14. A goods holder and adapter assembly of clause A12 or A13, wherein the goods holder comprises at least one gripper hole in the upper edge of the goods holder, and the at least one projection is inserted into the at least one gripper hole of the goods holder.

A15. A goods holder and adapter assembly of any of clauses A12 to A14 when dependent from clause A9, wherein the inner rim section is inserted into the goods holder and is in contact with an inner surface of the goods holder.

A16. A goods holder and adapter assembly of any of clauses A12 to A15, wherein the adapter further comprises a central lid part, said central lid part completely covering a top side of the goods holder when said adapter is affixed to the upper edge of the goods holder.

A17. A goods holder and adapter assembly of clause A16, wherein said central lid part comprises two lid portions which are connected to the frame by a respective hinge and which can each be pivoted about their respective hinge so as to lift up or drop down to allow access to the interior of the goods holder.

A18. A stack of goods holders comprising:
the goods holder and adapter assembly of any of clauses A12 to A17, and
a lower goods holder,
wherein the goods holder and adapter assembly is stacked on top of the lower goods holder, such that the adapter is sandwiched between the goods holder and the lower goods holder.

A19. An automated storage and retrieval system comprising a framework structure, wherein the framework structure comprises:
upright members;
a storage volume comprising storage columns provided between the members, wherein goods holders are stackable in stacks within the storage columns;
a rail system provided on top of the upright members;
wherein the automated storage and retrieval system comprises container handling vehicles moving on the rail system; and
a stack of goods holders as claimed in clause A18.

### LIST OF REFERENCE NUMBERS

1 Storage and retrieval system
19 Frame
21 Projection
23 Inner rim section
25 Flange
27 Base of the goods holder
29a-29d Sides of the goods holder
31 Upper edge of the goods holder
33 Gripper holes of the goods holder
44 Grippers of the gripper device
46 Gripper device
47 Bin bottom sensor
49 Central lid part
49a-49b Lid portions
100 Framework structure
102 Upright members of framework structure
104 Storage grid
105 Storage column
106 Storage container/Goods holder
106L Lower goods holder
106′ Particular position of storage container
107 Stack of storage containers
108 Rail system
109 Adapter
110 Parallel rails in first direction (X)
111 Parallel rails in second direction (Y)
112 Access opening
119 First port column
201 Container handling vehicle/Remotely operated vehicle
201a Vehicle body of the container handling vehicle 201
201b Drive means/wheel arrangement, first direction (X)
201c Drive means/wheel arrangement, second direction (Y)
301 Cantilever-based container handling vehicle/Remotely operated vehicle
301a Vehicle body of the container handling vehicle 301
301b Drive means in first direction (X)
301c Drive means in second direction (Y)
304 Gripper device of the vehicle 301
401 Container handling vehicle/Remotely operated vehicle
401a Vehicle body of the container handling vehicle 401
401b Drive means in first direction (X)
401c Drive means in second direction (Y)
404 Gripper device of the container handling vehicle 401
500 Control system
X First direction
Y Second direction
Z Third direction

1-19. (canceled)

20. A method for adapting a goods holder handled by a remotely operated vehicle of a grid-based storage and retrieval system, said method comprising:
providing an adapter comprising a quadrangular frame with at least one hollow projection extending perpendicularly from said quadrangular frame,
engaging the at least one hollow projection by a gripper of a gripper device of said remotely operated vehicle,
positioning said remotely operated vehicle so that said adapter is positioned above and aligned with the goods holder, with the at least one hollow projection aligned with a corresponding gripper hole in an upper edge section of the goods holder,
lowering the adapter using the gripper device so that the quadrangular frame is adjacent the upper edge section of the goods holder,
affixing the adapter to the upper edge section of the goods holder by inserting the at least one hollow projection into the corresponding gripper hole of the goods holder.

21. The method as claimed in claim 20, the method comprising:
affixing the adapter to the upper edge section of the goods holder when the goods holder is disposed in a storage column of the grid-based storage and retrieval system.

22. The method as claimed in claim 20, said method comprising:
pushing the adapter downward when said quadrangular frame is adjacent the upper edge section of the goods holder such that the at least one hollow projection becomes firmly secured in the corresponding gripper hole.

23. The method as claimed in claim 20, said method comprising:
passing the gripper of the gripper device through the at least one hollow projection when the at least one hollow projection is inserted in the corresponding gripper hole of the goods holder,
engaging the goods holder by said gripper,
lifting the goods holder.

24. An adapter for a goods holder, the adapter comprising:
a quadrangular frame;
at least one projection extending perpendicularly from the quadrangular frame, wherein the at least one projection is hollow.

25. An adapter in accordance with claim 24, wherein the at least one projection has an open distal end.

26. An adapter in accordance with claim 24, wherein the at least one projection has rounded edges.

27. An adapter in accordance with claim 24, wherein the at least one projection tapers away from the quadrangular frame.

28. An adapter in accordance with claim 24, wherein the adapter comprises an inner rim section which extends perpendicularly from the quadrangular frame in a same direction as the at least one projection.

29. An adapter in accordance with claim 24, wherein at least one corner section of the quadrangular frame comprises a guiding flange extending perpendicularly from the quadrangular frame in an opposite direction to a direction that the at least one projection extends.

30. A goods holder and adapter assembly, comprising:
a goods holder comprising a base and four sides extending from the base, the four sides defining an upper edge opposite the base; and
the adapter as claimed in claim 24,
wherein the adapter is attached to the upper edge of the goods holder, and wherein the adapter does not extend outwardly of an outer perimeter of the goods holder defined by the four sides.

31. A goods holder and adapter assembly in accordance with claim 30, wherein the adapter is releasably affixed to the upper edge of the goods holder.

32. A goods holder and adapter assembly as claimed in claim 30, wherein the goods holder comprises at least one gripper hole in the upper edge of the goods holder, and the at least one projection is inserted into the at least one gripper hole of the goods holder.

33. A goods holder and adapter assembly as claimed in claim 30, wherein an inner rim section of the adapter is inserted into the goods holder and is in contact with an inner surface of the goods holder.

34. A goods holder and adapter assembly as claimed in claim 30, wherein the adapter further comprises a central lid part, said central lid part completely covering a top side of the goods holder when said adapter is affixed to the upper edge of the goods holder.

35. A goods holder and adapter assembly as claimed in claim 34, wherein the central lid part comprises two lid portions which are connected to the quadrangular frame by a respective hinge and which can each be pivoted about their respective hinge so as to lift up or drop down to allow access to an interior of the goods holder.

36. A stack of goods holders comprising:
the goods holder and adapter assembly as claimed in claim 30, and
a lower goods holder,
wherein the goods holder and adapter assembly is stacked on top of the lower goods holder, such that the adapter is sandwiched between the goods holder and the lower goods holder.

37. An automated storage and retrieval system comprising a framework structure, wherein the framework structure comprises:
upright members;
a storage volume comprising storage columns provided between the upright members, wherein goods holders are stackable in stacks within the storage columns;
a rail system provided on top of the upright members;
wherein the automated storage and retrieval system comprises container handling vehicles moving on the rail system; and
a stack of goods holders as claimed in claim 36.
